(19) United States
(12) Patent Application Publication
(10) Pub. No.: US 2010/0146540 A1
(43) Pub. Date: Jun. 10, 2010

(54) RECEIVING DEVICE, COMMUNICATIONS SYSTEM, RECEIVING DEVICE CONTROL METHOD AND PROGRAM

(76) Inventor: Tomohiko SAKAMOTO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/631,601

(22) Filed: Dec. 4, 2009

(30) Foreign Application Priority Data
May 12, 2008 (JP) P2008-311625

(51) Int. Cl. H04N 7/10; H04N 5/445

(52) U.S. Cl. 725/32; 348/563; 348/E05.099

(57) ABSTRACT

A receiving device according to the present invention includes a receiving portion that acquires main program data and CM data via a communications network and a control portion that acquires a CM display time included in the main program data, displays the main program data during a time period other than the CM display time and displays the CM data during the CM display time. When one of a timing at which a power source is switched on and a timing at which a channel is changed coincides with the CM display time, the control portion does not display the CM data and displays the main program data during the CM display time.

### BACKGROUND OF THE INVENTION

1. Field of the Invention

The present invention relates to a receiving device, a communications system, a receiving device control method and a program.

2. Description of the Related Art

Recently, in broadcast wave systems in which a main stream and a CM stream are multiplexed, technology is known in which, when operation of a channel by a user is detected, the CM stream is selected before the main stream selection, and the CM viewing time of the user is secured, regardless of a position at which the user starts viewing (refer to Published Japanese Translation of PCT Application No. JP-T-2007-515838).

### SUMMARY OF THE INVENTION

However, if the CM is being broadcast when the user performs channel operation or switches on a power source, the user cannot verify the content of the selected program. As a result, it is possible that the user may switch over to another channel. In this case, despite the fact that a certain program provider's channel is selected, due to the fact that the CM is running when the power source is switched on or when the channel is selected, the user changes to another channel, resulting in the loss of a viewer for the program provider.

In light of the foregoing, it is desirable to provide a novel and improved receiving device, communications system, receiving device control method and program that are capable of causing a main program to be viewed, even when a timing at which the power source is switched on or at which channel selection is performed coincides with a CM display time.

According to an embodiment of the present invention, there is provided a receiving device that includes a receiving portion that acquires main program data and CM data via a communications network and a control portion that acquires a CM display time included in the main program data, displays the main program data during a time period other than the CM display time and displays the CM data during the CM display time. In this configuration, one of a timing at which a power source is switched on and a timing at which a channel is changed coincides with the CM display time, the control portion does not display the CM data and displays the main program data during the CM display time.

According to the above-described structure, the main program data and the CM data are acquired via the communications network. The CM display time included in the main program data is acquired, the main program data is displayed during a time period other than the CM display time and the CM is displayed during the CM display time. Then, when one of the power source being switched on and the channel switchover being performed coincides with the CM display time, the CM is not displayed and the main program is displayed during the CM display time. The viewer can therefore be deterred from switching to another channel as a result of the CM being displayed when the power source is switched on or when the channel is changed and it is possible to get the viewer to continuously view the channel initially selected.

In this configuration, the receiving device may also include a CM data storage portion that accumulates the CM data. The control portion may displays the CM data accumulated in the CM data storage portion during the CM display time.

In this configuration, the receiving device may also include a channel selection log storage portion that holds a log of channel selections for a predetermined period of time. When a chosen channel is selected for the first time within the predetermined period of time, when a timing of the channel selection coincides with the CM display time, the control portion does not display the CM data and displays the main program data during the CM display time, and when a channel that has already been selected within the predetermined period of time is re-selected, when a timing of the channel selection coincides with the CM display time, the control portion displays the CM data during the CM display time.

In this configuration, a time band of the main program data corresponding to the CM display time may also include data that is the same as the data of the main program immediately preceding the time band.

In this configuration, a time band of the main program data corresponding to the CM display time may also include main program information, the main program information containing one of a summary and highlights of the main program.

In this configuration, the main program data may also be live broadcast data, and a time band of the main program data corresponding to the CM display time may also include data that is continuously broadcast live from before the time band.

In this configuration, a time band of the main program data corresponding to the CM display time may also include data that is the same as the main program data immediately preceding the time band and also includes the CM data.

In this configuration, the receiving portion may also receive, via the communications network, image data relating to the main program that is for display during the CM display time, and when one of the timing at which the power source is switched on and the timing at which the channel is changed coincides with the CM display time, the control portion may display the image data relating to the main program during the CM display time.

In this configuration, the main program data and the CM data may also be transmitted together as far as a multicast bifurcation point in the communications network, the receiving portion acquires the main program data during a time period other than the CM display time and acquires the CM data during the CM display time, and when one of the timing at which the power source is switched on and the timing at which the channel is changed coincides with the CM display time, based on a command from the control portion, the receiving portion does not acquire the CM data and acquires the main program data during the CM display time.

According to another embodiment of the present invention, there is provided a communications system that includes a server that transmits main program data and CM data to a receiving device via a communications network; and a receiving device. The receiving device includes a control portion that acquires a CM display time included in the main program data, displays the main program data during a time period other than the CM display time and displays the CM data during the CM display time. When one of a timing at which a power source is switched on and a timing at which a channel is changed coincides with the CM display time, the control portion does not display the CM data and displays the main program data during the CM display time.

According to the above-described structure, the main program data and the CM data are transmitted from the server to the receiving device via the communications network. The main program data and the CM data are acquired by the receiving device, and the CM display time included in the main program data is acquired. Then, the main program is displayed during a time period other than the CM display time and the CM is displayed during the CM display time. When a timing at which the power source is switched on or a timing at which the channel is changed coincides with the CM display time, the CM is not displayed and the main program is displayed during the CM display time. The viewer can therefore be deterred from switching to another channel as a result of the CM being displayed when the power source is switched on or when the channel is changed and it is possible to get the viewer to continuously view the channel initially selected.

In this configuration, the server may also include an image transmitting portion that transmits to the receiving device image data relating to the main program that is for display during the CM display time. When one of the timing at which the power source is switched on and the timing at which the channel is changed coincides with the CM display time, the control portion of the receiving device may displays, during the CM display time, images of the image data transmitted from the image transmitting portion.

According to another embodiment of the present invention, there is provided a receiving device control method, that includes the steps of acquiring main program data and CM data via a communications network, acquiring a CM display time that is included in the main program data and displaying the main program data in a time period other than the CM display time, displaying the CM data during the CM display time; and displaying the main program data during the CM display time instead of displaying the CM data, when one of a timing at which a power source is switched on and a timing at which a channel is changed coincides with the CM display time.

According to the above-described structure, the main program data and the CM data are acquired via the communications network. The CM display time included in the main program data is acquired, the main program is displayed during a time period other than the CM display time and the CM is displayed during the CM display time. Then, when a timing at which the power source is switched on or a timing at which the channel is changed coincides with the CM display time, the CM is not displayed and the main program is displayed during the CM display time. The viewer can therefore be deterred from switching to another channel as a result of the CM being displayed when the power source is switched on or when the channel is changed and it is possible to get the viewer to continuously view the channel initially selected.

According to another embodiment of the present invention, there is provided a program that includes instructions that command a computer to function as a device that acquires main program data and CM data via a communications network, a device that acquires a CM display time that is included in the main program data and displays the main program data during a time period other than the CM display time, a device that displays the CM data during the CM display time; and a device that, when one of a timing at which a power source is switched on and a timing at which a channel is changed coincides with the CM display time, does not display the CM data and displays the main program data during the CM display time.

According to the above-described structure, the main program data and the CM data are acquired via the communications network. The CM display time included in the main program data is acquired, the main program is displayed during a time period other than the CM display time and the CM is displayed during the CM display time. Then, when a timing at which the power source is switched on or a timing at which the channel is changed coincides with the CM display time, the CM is not displayed and the main program is displayed during the CM display time. The viewer can therefore be deterred from switching to another channel as a result of the CM being displayed when the power source is switched on or when the channel is changed and it is possible to get the viewer to continuously view the channel initially selected.

According to the embodiments of the present invention described above, a receiving device, a communications system, a receiving device control method and a program are provided that can cause the main program to be viewed, even when a timing at which the power source is switched on or at which the channel is changed coincides with the CM display time.

### BRIEF DESCRIPTION OF THE DRAWINGS

FIG. 1 is a schematic diagram showing a communications system according to an embodiment of the present invention;

FIG. 2 is a schematic diagram showing a structure of a receiving terminal device according to the embodiment of the present invention;

FIG. 3 is a schematic diagram showing a program data stream;

FIG. 4 is a schematic diagram showing an example in which, at a position at which a CM should be inserted in the program data stream, CM data is inserted along with a section of the program data immediately preceding the CM, and both the main program broadcast and the CM are displayed on a display device; and

FIG. 5 is a flow chart illustrating a procedure of a process on the receiving terminal device according to the embodiment of the present invention.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

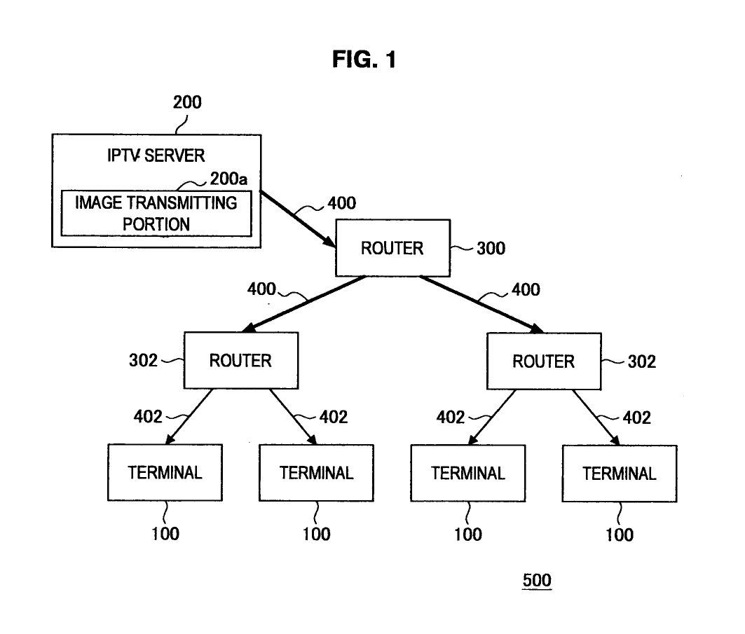

FIG. 1 is a schematic diagram showing a communications system 500 according to an embodiment of the present invention. As shown in FIG. 1, the communications system 500 includes a server 200 that is a host device that distributes a broadcast program, and receiving terminal devices 100 that are user terminals that receive the broadcast program in each household etc. The communication system 500 further includes routers 300 and 302 that relay data between the server 200 and the receiving terminal devices 100. As shown in FIG. 1, in the communications system 500 according to the present embodiment, the receiving terminal devices 100 receive and play back a multicast that is distributed by the server 200. In the present embodiment, the server 200 is an internet protocol television (IFFY) server that distributes video via the Internet, but the server functions need not be limited to this example.

The server 200 and the router 300, and the router 300 and the routers 302 are connected by transmission lines 400 that have a relatively large transmission capability. Further, the routers 302 and the receiving terminal devices 100 are connected by transmission lines 402 that have a relatively small data transmission capability, such as narrow bandwidth ADSL cables, for example. The transmission lines 400 and 402 are telephone lines, power lines and the like. The transmission lines 400 can simultaneously transmit a plurality of HD images, such as main program data for TV programs, for example. Meanwhile, although it is assumed that the transmission lines 402 can simultaneously transmit main program data HD images along with comparatively low bit rate images that have a lower resolution than the HD images, the transmission lines 402 may also be capable of simultaneously transmitting the plurality of HD images, in a similar manner to the transmission lines 400.

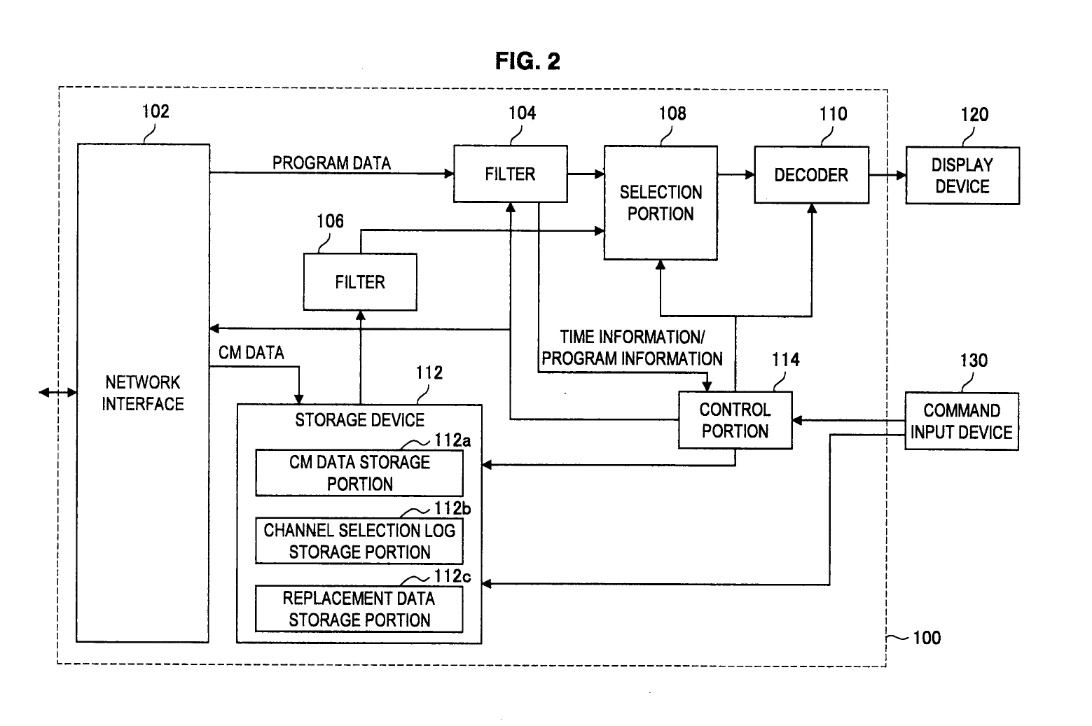

FIG. 2 is a schematic diagram showing a structure of the receiving terminal device 100. The receiving terminal device 100 includes a network interface 102, a filter 104, a filter 106, a selection portion 108, a decoder 110, a storage device 112 and a control portion 114. In addition, a display device 120 and a command input device 130 are connected to the receiving terminal device 100. Each of the structural elements of the receiving terminal device 100 shown in FIG. 2 can be configured by a processing device (a microprocessor) such as a CPU etc., a program (software) that causes the processing device to function, the storage device 112 and an input/output device that is an interface with external devices. In this case, the program that causes the processing device to function can be stored in the storage device 112.

The display device 120 is a display such as a liquid crystal display, and, in addition to functioning as a normal television monitor, it may be formed integrally with the receiving terminal device 100. The command input device 130 is used when switching a power source for the receiving terminal device 100 on or off, or when changing a broadcast channel that is received by the receiving terminal device 100. The command input device 130 is an input device such as a keyboard etc., but need not be limited to the keyboard. The command input device 130 can be, for example, a remote control that operates the receiving terminal device 100. In addition, the command input device 130 may be formed integrally with the receiving terminal device 100.

The network interface 102 is formed of communications hardware and software that includes various protocols. The network interface 102 is connected to the transmission line 402 and receives a program data stream and a CM data stream. Here, the program data transmitted from the transmission line 402 is data that has a high bit rate, such as HD images etc. In addition, as the CM data is accumulated and then displayed, even if it has a low bit rate, as it is received over a longer time period than its display time period, it can also be converted to HD images. On the other hand, the CM data transmitted is data with a low bit rate that has a lower resolution than the HD images. Note that, when the transmission line 402 connecting the router 302 and the receiving terminal device 100 is a line that is capable of high capacity data transmission, both the program data and the CM data may be transmitted via the transmission line 402 as high bit rate HD images.

Of data received by the network interface 102, the program data is transmitted to the filter 104. The format of the program data is, for example, MPEG transport stream (TS). Image data (video data) and voice data (audio data) in the program data can be separated by filtering in the filter 104, based on a packet identifier (PID). The separated video data and audio data are transmitted to the selection portion 108. In addition, the filter 104 can also separate out service information (SI) contained in the program data, and the separated service information is transmitted to the control portion 114. The service information includes program information and time information, such as CM start and end times (a CM display time). Note that, program information and time information, such as the CM start and end times, can also be acquired by multicast or unicast via a network formed by the transmission lines 400 and the transmission lines 402, and not necessarily from the program data stream.

Further, the CM data is acquired at a lower bit rate via the network formed by the transmission lines 400 and the transmission lines 402, separately from the program data. The CM data is acquired after the program data has been received and while the program is being viewed. The CM data received by the network interface 102 is transmitted to the storage device 112. The CM data is then separated by channel and accumulated in a CM data storage portion 112a in the storage device 112. When the CM display time arrives, the accumulated CM data is transmitted from the selection portion 108 to the decoder 110, and is displayed on the display device 120, switching from the display of the main program. The storage device 112 can be, for example, a non-volatile memory, such as a hard disk drive, a flash memory and the like. The CM data accumulated in the storage device 112 is transmitted to the filter 106 based on a command from the control portion 114. The filter 106 extracts audio data and video data from the CM data and transmits the extracted data to the selection portion 108.

The service information transmitted from the filter 104 to the control portion 114 includes time information (the CM display time) that indicates a time at which the CM is inserted into the program data. In other words, the data transmitted to the control portion 114 includes information about a time period over which the main program is broadcast. The control portion 114 of the receiving terminal device 100 controls the selection portion 108 based on the CM display time transmitted from the filter 104. During the time band over which the main program is broadcast, the control portion 114 transmits the main program data, which has been transmitted to the selection portion 108 via the filter 104, to the decoder 110.

The program data that has been transmitted to the selection portion 108 is transmitted to the decoder 110, decoded by the decoder 110 and then transmitted to the display device 120. The decoder 110 includes hardware or a processing device and a program that causes the hardware or the processing device to function. The display device 120 displays the decoded program data. In this way, based on the time information of the program data received via the network interface 102, when the received data is the main program data, the receiving terminal device 100 transmits the main program data to the decoder 110 via the selection portion 108 and displays the main program broadcast.

On the other hand, based on the time information transmitted from the filter 104, during a time band in which the CM is inserted into the program data (the CM display time), the control portion 114 of the receiving terminal device 100 outputs a command to the selection portion 108 such that input from the filter 106 is transmitted to the decoder 110. Based on the command from the control portion 114, the selection portion 108 switches from the program data transmitted from the filter 104 to the CM data transmitted from the filter 106 and outputs the CM data to the decoder 110. In this way, the CM data transmitted from the filter 106 is output from the selection portion 108 and transmitted to the decoder 110.

The CM data transmitted to the selection portion 108 is transmitted to the decoder 110, decoded by the decoder 110 and then transmitted to the display device 120. The display device 120 displays the decoded CM data.

In this way, in the receiving terminal device 100 according to the present embodiment, while the main program data is being received via the network interface 102, the main program data is transmitted to the display device 120 via the filter 104, the selection portion 108 and the decoder 110. As a consequence, a viewer can view the main program displayed on the display of the display device 120.

In addition, while the program data is being displayed on the display device 120, when it is detected, in accordance with the time information transmitted from the filter 104, that the CM display time has arrived, the control portion 114 switches over the data transmitted from the selection portion 108 to the decoder 110. In this way, the CM data accumulated in the storage device 112 is transmitted to the decoder 110, and the CM broadcast is displayed on the display device 120. As a result, the CM can be inserted during the main program.

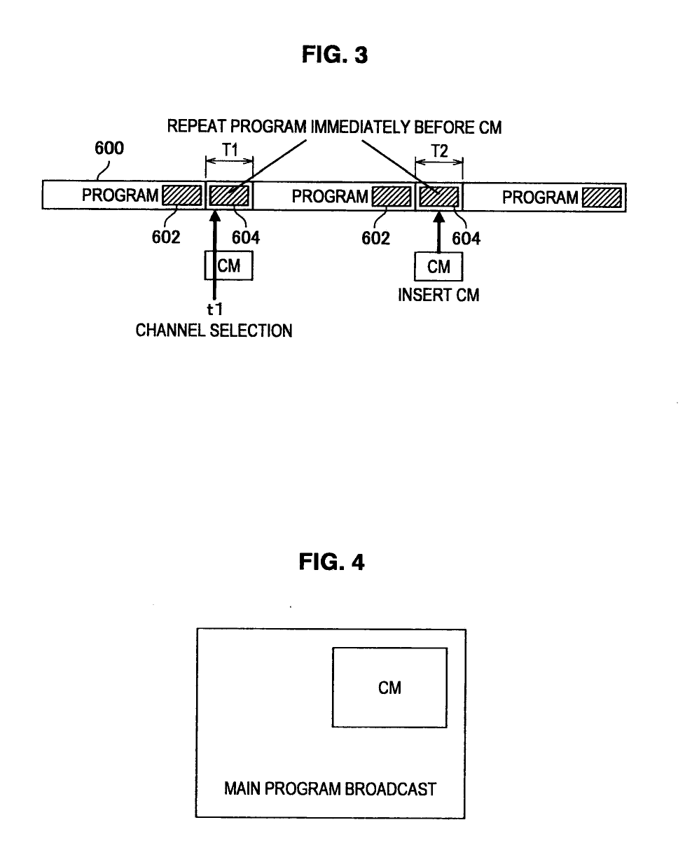

FIG. 3 is a schematic diagram showing a program data stream 600. As shown in FIG. 3, the program data stream 600 includes the CM display times (segments T1 and T2) that are set in advance. As described above, the service information includes this CM display time information. Therefore, when the segment T1 or the segment T2 arrives, the control portion 114 switches over the data transmitted from the selection portion 108 to the decoder 110, and thus the CM can be inserted in the segments T1 and T2.

In the present embodiment, in the program data stream 600 shown in FIG. 3, data 604 is inserted during the CM display times (the segments T1 and T2), the data 604 being the same as main program data 602 that is a section of data immediately preceding the CM.

When the viewer is continuously viewing the main program, in the time band in which the CM is inserted in the manner described above, the output of the selection portion 108 is switched over in accordance with the command from the control portion 114, and thus the CM data is inserted into the CM display times (the segments T1 and T2).

On the other hand, if a timing at which the viewer switches on the power source, or a timing at which the viewer changes the channel of the program being received, coincides with the segment T1 or the segment T2, the control portion 114 does not switch over the output of the selection portion 108 and transmits the program data stream 600 to the decoder 110.

In this way, at a timing at which the power source is switched on, or at a timing at which the channel is changed, a section of the main program data immediately preceding the segment T1 or the segment T2 is displayed on the display device 120, the above-described section of the main program data being inserted into the segment T1 and the segment T2 of the program data in advance. As a result, even if a timing at which the power source is switched on or at which the channel is changed coincides with a timing in which the CM is originally inserted, the viewer can view the main program.

For example, in FIG. 3, if the viewer switches on the power source or changes the channel (performs channel selection) at a time point t1, the time t1 coincides with the CM display time (the segment T1) and the control portion 114 therefore does not perform control to switch over the output from the selection portion 108. As a result, the program data stream 600 transmitted from the filter 104 is transmitted to the decoder 110. In this way, at the time t1, the section of the main program data immediately preceding the segment T1, which is inserted into the segment T1 of the program data in advance, is displayed on the display device 120.

Meanwhile, after the viewer has switched on the power source or changed the channel (performed channel selection) at the timing of the time point t1, when the next CM display time (the segment T2) arrives, the control portion 114 switches over the output of the selection portion 108 and inserts the CM data into the segment T2. In this way, the main program can be broadcast during the CM broadcast time band only when the power source is switched on, or when the channel is changed.

If the CM is broadcast when the power source is switched on or when the channel is changed, normally, because the viewer wishes to view the main program, it can be assumed that the viewer will switch to another channel. In the present embodiment, when the power source is switched on or when the channel is changed, the viewer does not view the CM, and switching to another channel by the viewer can thus be avoided when switching on the power source or when changing channels.

On the other hand, when the power source is switched on or the channel is changed while the main program is being displayed and not at a timing at which the CM is inserted, the main program is broadcast. Then, when the timing for the next CM to be inserted arrives, the selection portion 108 selects the CM data and the CM data is transmitted to the decoder 110. In this way, the viewer can view the CM.

A log of channel selections by the viewer, as input from the command input device 130, is recorded by the receiving terminal device 100 in a channel selection log storage portion 112b in the storage device 112. The log of channel selections by the viewer and the CM data are stored for a predetermined period of time. Based on the log of channel selections over the predetermined period of time, when a chosen channel is selected for a first time within the predetermined period of time, if the channel selection coincides with the CM display time, as described above, the CM is not inserted and a repeat broadcast of the main program is displayed during the CM display time. On the other hand, when a channel that has already been selected within the predetermined period of time is selected a second time, the viewer is already aware of the content of the main program on that channel, so even if the timing of the channel selection coincides with the CM display time, the repeat broadcast of the main program is not displayed and the CM is inserted. In this way, an excessive decrease in opportunities to view the CM can be avoided.

In addition, in the example shown in FIG. 3, the section of the program data immediately preceding the CM is inserted as the repeat broadcast in the position in which the CM should be inserted, but the inserted data need not necessarily be limited to this example, and the program provider (the broadcast station) can freely set the data for insertion. For example, data that displays program highlights or a program synopsis may be inserted in the position in which the CM should be inserted. In this way, when a timing at which the power source is switched on or at which the channel is changed coincides with the CM display time, the viewer can see the program highlights or the program synopsis etc., thus making it possible to avoid switching over to another channel immediately after switching on the power source or changing the channel.

Furthermore, when the main program is a live sports broadcast or the like, in the CM display time during the program stream, the live broadcast data may be continuously inserted as it is. In this case also, when a timing at which the power source is switched on or at which the channel is changed coincides with the CM display time, the viewer can view the live broadcast without interruption, and thus switching over to another channel immediately after switching on the power source or changing the channel can be deterred.

FIG. 4 is a schematic diagram showing an example in which, at a position in which the CM should be inserted during the program data stream 600, the CM data is inserted along with the section of the program data immediately preceding the CM, and both the main program broadcast and the CM are displayed on the display device 120. In this way, by inserting the main program and the CM in the CM display time band (the segments T1 and T2) in advance, when the power source is switched on or when the channel is changed, the viewer can view both the main program and the CM. It is therefore possible to avoid the viewer switching over to another channel, and at the same time, the viewer can also view the CM. In this case also, after the power source has been switched on or after the channel has been changed, when the next CM display time arrives, only the CM broadcast inserted in accordance with a command from the control portion 114 is displayed on the display device 120.

With the above-described structure, it is described that, when a timing at which the power source is switched on or a timing at which the channel is changed coincides with the CM display time, display is performed in accordance with data inserted in advance into the program data stream 600. However, images acquired separately from the server 200 can be displayed. In this case, an image transmitting portion 200a of the server 200 shown in FIG. 1 transmits image data for insertion in the CM display time to the receiving terminal device 100 separately from the program data and the CM data. The storage device 112 of the receiving terminal device 100 stores the transmitted image data. Then, when a timing at which the power source is switched on or at which the channel is changed coincides with the CM display time, the control portion 114, based on the CM display time, transmits the image data stored in the storage device 112 to the selection portion 108 and causes it to be displayed on the display device 120.

Further, when the power source is switched on or the channel is changed immediately preceding the CM display time segments T1 and T2, if data for the next CM is not completely acquired during reception of the main program stream, replacement CM data that is stored in advance in a replacement data storage portion 112c of the storage device 112 is used. In this case, the replacement CM data is displayed on the display device 120.

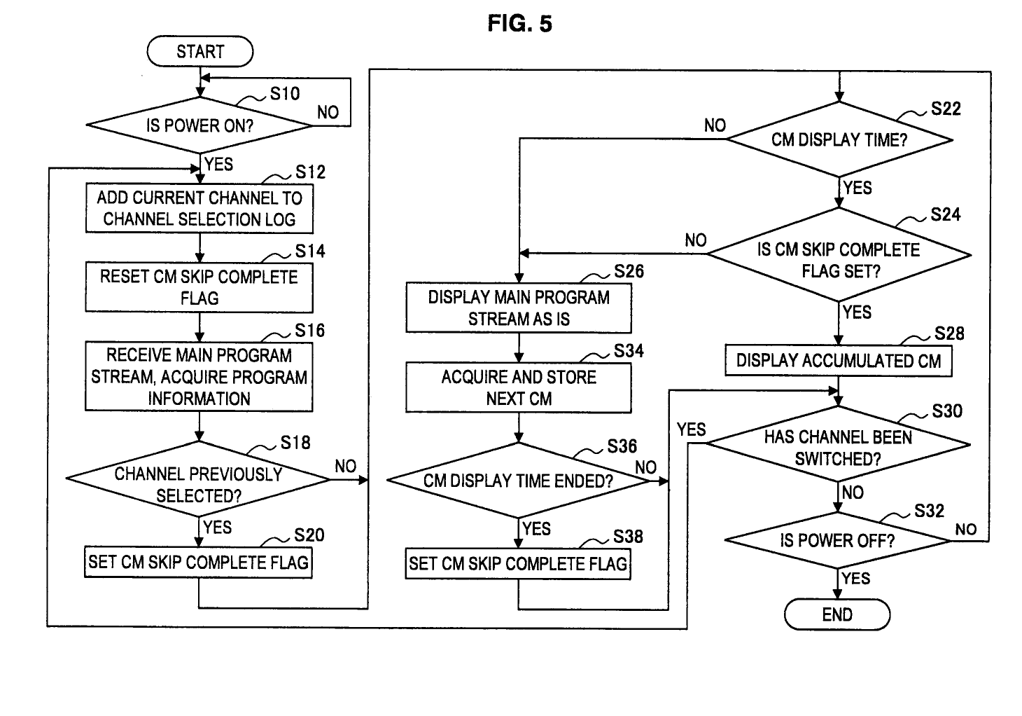

Next, a processing procedure by the receiving terminal device 100 according to the present embodiment by referring to a channel selection log will be explained with reference to a flow chart shown in FIG. 5. First, at step S10, it is determined whether or not the power source of the receiving terminal device 100 has been switched on. When the power source is on at step S10, the process advances to step S12, and the channel currently selected when the power source is switched on is added to the channel selection log.

At the next step S14, a CM skip complete flag is reset, and at the next step S16, the main program stream is received and program information is acquired from the service information that is included in the program data. As described above, time information for the time at which the CM is inserted is included in the service information.

At the next step S18, it is determined whether or not the channel has been previously selected. If the channel has been previously selected, the process advances to step S20. At step S20, the CM skip complete flag is set, and the process advances to step S22. On the other hand, if it is determined at step S18 that the channel has not been previously selected, the process advances to step S22 without setting the CM skip complete flag at step S20. At step S22, it is determined whether or not it is the CM display time and if it is the CM display time, the process advances to step S24.

At step S24, it is determined whether or not the CM skip complete flag is set. If the CM skip complete flag is set, the process advances to step S28. At step S28, the CM data accumulated in the storage device 112 is transmitted from the selection portion 108 to the decoder 110, and is displayed on the display of the display device 120. In this way, when it is the CM display time and when the CM skip complete flag is set, the CM data accumulated in the storage device 112 is transmitted from the selection portion 108 to the decoder 110 and the CM is displayed on the display device 120.

At the next step S30, it is determined whether or not the channel has been changed. When the channel has been changed, the process returns to step S12, and performs subsequent processing. If the channel has not been changed at step S30, the process advances to step S32, and it is determined whether or not the power source has been switched off. If the power source is off at step S32, the process ends. On the other hand, if the power source is not off at step S32, the process returns to step S22 and performs subsequent processing.

In addition, when it is determined at step S22 that it is not the CM display time, or when the CM skip complete flag is not set at step S24, the process advances to step S26. At step S26, the main program stream is transmitted to the decoder 110 as it is, and the main program is displayed on the display of the display device 120.

After step S26, the process advances to step S34. At step S34, while receiving the main program stream, the CM data to be inserted into the next CM display time is acquired via the transmission line 402 and accumulated in the storage device 112. The acquisition of the CM data is parallel to reception of the main program stream and is performed as a separate task. At the next step S36, it is determined whether or not the CM display time has ended. If the CM display time has ended, the CM skip complete flag is set at step S38 and the program advances to step S30. On the other hand, if the CM display time has not ended at step S36, the process advances to step S30 without setting the CM skip complete flag.

According to the process shown in FIG. 5, when the power source is switched on (at step S10) or when the channel is changed (at step S30), it is determined whether or not the currently selected channel is a channel that has been previously selected. It is then determined whether or not it is the CM display time (at step S22), and if it is the CM display time and the channel has been previously selected, the CM is displayed. On the other hand, if it is not the CM display time, the main program stream is displayed (at step S26). Furthermore, even if it is the CM display time, when the channel is not a previously selected channel, as the channel is selected for the first time, the main program stream is displayed.

As a result, when the power source is switched on or when the channel is changed, when it is the CM display time and when the current channel is the channel that has been previously selected, the CM can be displayed. In this case, as the current channel is the channel that has been previously selected, the viewer is already aware of the content of the main program on that channel. Therefore, when the time at which the power source is switched on or the channel is changed coincides with the CM display time, even if the CM is being displayed, there is a lower likelihood that the viewer will immediately switch to another channel. For that reason, by displaying the CM when the power source is switched on or when the channel is changed, the function of the CM can be effectively deployed. Note that, in determining whether or not the channel has previously been selected, the determination can be made, for example, by ascertaining whether or not the current channel was previously selected within a predetermined period of time (a period of several minutes, for example) before the power source is switched on or before the channel is changed.

Note also that, as described above, when the power source is switched on or the channel is changed immediately before the CM display time, for the CM display at step S28, the replacement CM that is stored in advance in the storage device 112 is displayed.

Next, a case will be explained in which high resolution data, such as HD images etc. are acquired as the CM data also. As described above, in the system shown in FIG. 1, the transmission lines 400 can simultaneously transmit a plurality of HD images. For that reason, in addition to the HD image program data stream, the server 200 can transmit the HD image CM data stream to the routers 302 via the transmission lines 400, using a different IP address. In this case, as well as receiving the program stream during a time period other than the CM display time, the receiving terminal device 100 can switch over the IP address during the CM display time and thus switch to receiving the CM data stream. In this way, the high resolution CM can be displayed. In this case, the control portion 114 switches over the IP address based on the CM display time that can be acquired from the program data, acquires the CM data stream, and displays the acquired CM data stream on the display device 120. In this case, the accumulation of the CM data in the storage device 112 is not necessary. Also in this case, the program data stream is similar to that shown in FIG. 3. Then, when a timing at which the power source is switched on or a timing at which the channel is changed coincides with the CM display time, by not switching over to the CM stream, the main program broadcast immediately preceding the CM display time can be displayed.

As described above, according to the present embodiment, when a timing at which the power source is switched on or at which the channel is changed coincides with the CM display time, repeated broadcast of the main program is displayed and thus the viewer can confirm the content of the main program. The viewer can therefore be deterred from switching to another channel as a result of the CM being displayed when the power source is switched on and the program provider can thus encourage the selected channel to be continuously viewed.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2008-311625 filed in the Japan Patent Office on 5 Dec. 2008, the entire content of which is hereby incorporated by reference.

What is claimed is:

1. A receiving device comprising:
a receiving portion that acquires main program data and CM data via a communications network; and
a control portion that acquires a CM display time included in the main program data, displays the main program data during a time period other than the CM display time and displays the CM data during the CM display time,
wherein
when one of a timing at which a power source is switched on and a timing at which a channel is changed coincides with the CM display time, the control portion does not display the CM data and displays the main program data during the CM display time.

2. The receiving device according to claim 1, further comprising:
a CM data storage portion that accumulates the CM data;
wherein
the control portion displays the CM data accumulated in the CM data storage portion during the CM display time.

3. The receiving device according to claim 1, further comprising:
a channel selection log storage portion that holds a log of channel selections for a predetermined period of time;
wherein
when a chosen channel is selected for the first time within the predetermined period of time, when a timing of the channel selection coincides with the CM display time, the control portion does not display the CM data and displays the main program data during the CM display time, and
when a channel that has already been selected within the predetermined period of time is re-selected, when a timing of the channel selection coincides with the CM display time, the control portion displays the CM data during the CM display time.

4. The receiving device according to claim 1, wherein
a time band of the main program data corresponding to the CM display time includes data that is the same as the data of the main program immediately preceding the time band.

5. The receiving device according to claim 1, wherein
a time band of the main program data corresponding to the CM display time includes main program information, the main program information containing one of a summary and highlights of the main program.

6. The receiving device according to claim 1, wherein
the main program data is live broadcast data, and a time band of the main program data corresponding to the CM display time includes data that is continuously broadcast live from before the time band.

7. The receiving device according to claim 1, wherein
a time band of the main program data corresponding to the CM display time includes data that is the same as the main program data immediately preceding the time band and also includes the CM data.

8. The receiving device according to claim 1, wherein
the receiving portion receives, via the communications network, image data relating to the main program that is for display during the CM display time, and
when one of the timing at which the power source is switched on and the timing at which the channel is changed coincides with the CM display time, the control portion displays the image data relating to the main program during the CM display time.

9. The receiving device according to claim 1, wherein
the main program data and the CM data are transmitted together as far as a multicast bifurcation point in the communications network,
the receiving portion acquires the main program data during a time period other than the CM display time and acquires the CM data during the CM display time, and
when one of the timing at which the power source is switched on and the timing at which the channel is changed coincides with the CM display time, based on a command from the control portion, the receiving portion does not acquire the CM data and acquires the main program data during the CM display time.

10. A communications system comprising:
a server that transmits main program data and CM data to a receiving device via a communications network; and
a receiving device that includes
a control portion that acquires a CM display time included in the main program data, displays the main program data during a time period other than the CM display time and displays the CM data during the CM display time, wherein
when one of a timing at which a power source is switched on and a timing at which a channel is changed coincides with the CM display time, the control portion does not display the CM data and displays the main program data during the CM display time.

11. The communications system according to claim 9, wherein
the server includes
an image transmitting portion that transmits to the receiving device image data relating to the main program that is for display during the CM display time, and
when one of the timing at which the power source is switched on and the timing at which the channel is changed coincides with the CM display time, the control portion of the receiving device displays, during the CM display time, images of the image data transmitted from the image transmitting portion.

12. A receiving device control method, comprising the steps of:
acquiring main program data and CM data via a communications network;
acquiring a CM display time that is included in the main program data and displaying the main program data in a time period other than the CM display time;
displaying the CM data during the CM display time; and
displaying the main program data during the CM display time instead of displaying the CM data, when one of a timing at which a power source is switched on and a timing at which a channel is changed coincides with the CM display time.

13. A program that comprises instructions that command a computer to function as:
a device that acquires main program data and CM data via a communications network;
a device that acquires a CM display time that is included in the main program data and displays the main program data during a time period other than the CM display time;
a device that displays the CM data during the CM display time; and
a device that, when one of a timing at which a power source is switched on and a timing at which a channel is changed coincides with the CM display time, does not display the CM data and displays the main program data during the CM display time.
